(19) United States
(12) Patent Application Publication
(10) Pub. No.: US 2025/0137500 A1
(43) Pub. Date: May 1, 2025

(54) CONNECTOR APPARATUS

(71) Applicant: TruBlue LLC, Louisville, CO (US)

(72) Inventors: Luke Smith, Louisville, CO (US); Owen Richard, Louisville, CO (US); David Woods, Sun Prairie, WI (US); Matthew T. Woerpel, Sun Prairie, WI (US); Edward Raleigh, Sun Prairie, WI (US); Jon Rasche, Sun Prairie, WI (US); Christi Miller, Sun Prairie, WI (US)

(73) Assignee: TruBlue LLC, Louisville, CO (US)

(21) Appl. No.: 18/923,980

(22) Filed: Oct. 23, 2024

Related U.S. Application Data
(60) Provisional application No. 63/593,555, filed on Oct. 27, 2023.

(51) Int. Cl. F16D 41/12; A63B 29/02; F16D 121/14; F16D 127/02; F16D 127/06

(52) U.S. Cl. CPC F16D 41/12; A63B 29/02; F16D 2121/14; F16D 2127/02; F16D 2127/06

(57) ABSTRACT

A connector apparatus includes a housing and a locking mechanism. The locking mechanism includes a rotatable disc that cooperates with the housing to selectively secure a connector therewith. The locking mechanism also includes a first pawl and a second pawl configured to engage with the disc and at least one lock lever configured to engage with the disc. A first connector is secured to the housing via the disc engaging the pawls and the lock lever thereby rotationally locking the disc. A second connector actuates the pawls to disengage the disc and the lock lever is manually actuated to disengage the disc so that the first connector can be released while simultaneously securing the second connector to the housing.

### CROSS-REFERENCE TO RELATED APPLICATIONS

This application claims priority to and the benefit of U.S. Provisional Patent Application No. 63/593,555, filed Oct. 27, 2023, and which is incorporated by reference herein in its entirety.

### INTRODUCTION

Line dispensing devices, such as auto-belay devices used for climbing or descender devices for workers and/or conveyances, can be used to protect against falls by retracting slack when the line is not under load and providing a braking force when the line is loaded, so that the weight (e.g., climber or worker) on the end of the line descends at a safe speed. Users of these line dispensing devices, however, can unintentionally miss-connect to the line dispensing device, thereby creating safety issues. Additionally, users of the line dispensing devices can release the line prior to connecting or after finishing with the line dispensing device, thereby allowing the line to undesirably retract.

Belay devices can be used to ensure that the user is safely connected to the line dispensing device and to prevent the user from unintentionally releasing the line. These belay devices include a line connector component that is mounted to an end of the line of the line dispensing device, a ground/wall anchor component that couples with the line connector component to anchor the line to a base of a structure (e.g., climbing wall) when not in use, and a harness connector component attached to the user's harness that couples with the line connector component to secure the harness to the line dispensing device. The line connector component has a locking mechanism to ensure that only one connecting component is coupled to the line connector component at a time and the other connecting component can only be used to release the line connector component coupling to the other.

However, at least some of these known belay devices have a harness connector component with a specialized shape to connect to the line connector component. These specialized shapes are costly to manufacture and are difficult to attach to user harnesses. Additionally, at least some known belay devices have a key with the ground/wall anchor component that is a high wear component, and that once worn, renders the component inoperable. Accordingly, improvement to belay devices are desired.

### Connector Apparatus

This disclosure describes examples of a connector apparatus for use in aerial amusement activities, such as, but not limited to, climbing wall activities that use auto-belays. In the connector apparatus described herein, features are described that facilitate the performance and security of the device. For example, the connector apparatus includes a locking mechanism disposed at least partially within a housing. A first connector can be secured to the housing and only released when a second connector is being secured to the housing. The locking mechanism includes a rotatable disk that is configured to secure the connector to the housing and with redundant safety features. The disc may be secured with one or more pawls, one or more lock levers, and/or one or more biasing members. Accordingly, a high performing and more efficient connector apparatus is provided.

In an aspect, the technology relates to a connector apparatus including: a housing having a first end and an opposite second end defining a longitudinal axis, the first end configured to couple to a line dispensing device, wherein the housing defines a first channel and a second channel each sized and shaped to receive at least a portion of a connector; and a locking mechanism disposed at least partially within the housing, the locking mechanism including: a disc rotatable around a rotation axis orthogonal to the longitudinal axis between at least a first position and a second position, the disc having a first notch and a second notch each sized and shaped to receive at least a portion of the connector, the disc also having a radially projecting leg; a first pawl and a second pawl, each pawl including a first arm positioned at a respective channel of the housing and a second arm selectively engageable with the disc; and at least one lock lever pivotably coupled to the housing, wherein the locking mechanism secures the connector to the housing when the connector is positioned at a distal end of the first channel and within the first notch such that the disc is in the first position, the disc is rotationally locked with the locking mechanism with the second pawl engaged with the disc and the radially projecting leg is engaged with the at least one lock lever, and wherein when a second connector is inserted into the second channel and the second notch, the second connector actuates the first arm of the second pawl to disengage the second pawl from the disc, additionally, when the at least one lock lever is actuated, the at least one lock lever disengages the radially projecting leg, thereby allowing the second connector to move and rotate the disc for securing within a distal end of the second channel via the first pawl and the at least one lock lever while simultaneously allowing the connector to release from the distal end of the first channel during rotation of the disc towards the second position.

In an example, the locking mechanism further includes a biasing member supported within the housing, and the disc has a radially projecting lug engaged with the biasing member, and a spring force of the biasing member is overcome in order to rotate the disc between the first position and the second position. In another example, the radially projecting lug is opposite from the radially projecting leg on the disc. In yet another example, the at least one lock lever includes a first lock lever and a second lock lever, the first lock lever and the second lock lever each pivotable between at least an unlocked position and a locked position, and when the disc is in the first position and the first lock lever is in the locked position, the radially projecting leg is engaged with the first lock lever, and when the disc is in the second position and the second lock lever is in the locked position, the radially projecting leg is engaged with the second lock lever. In still another example, the first lock lever and the second lock lever are engaged with each other such that both the first lock lever and the second lock lever move together between the unlocked position and the locked position. In an example, the first lock lever and the second lock lever are biased towards the locked position.

In another example, the disc includes a first shoulder and a second shoulder, the first shoulder configured to selectively engage with the first pawl and the second shoulder configured to selectively engage with the second pawl, and the first and second shoulders are axially offset from the radially projecting leg along the rotation axis. In yet another example, the first pawl and the second pawl are configured to pivot at least between an engaged position with the disc and a disengaged position with the disc, and when the first pawl is in the engaged position, the second pawl is in the disengaged position. In still another example, the connector directly contacts the first arm to move the second arm of the first pawl out of the engaged position. In an example, the first arm and the second arm are arranged in a L-shape. In another examples, when the disc is in the first position, the first pawl is in the disengaged position and the second pawl is in the engaged position, and the first arm of the second pawl extends over the second notch of the disc.

In yet another example, in order to move the second pawl out of the engaged position, the first arm of the second pawl is pivoted completely past the second notch of the disc. In still another example, the locking mechanism includes two sets of first and second pawls, each set disposed on an opposite side of the disc. In an example, the connector apparatus further includes the connector and the second connector, the connector and the second connector identical to each other.

In another aspect, the technology relates to a method of connecting to a connector apparatus including: providing a first connector secured to the connector apparatus, wherein the connector apparatus including a housing and a locking mechanism disposed at least partially within the housing, the housing having a first end and an opposite second end defining a longitudinal axis, the first end configured to couple to a line dispensing device, the housing defining a first channel and a second channel, the locking mechanism including a disc rotatable around a rotation axis orthogonal to the longitudinal axis, the disc having a first notch, a second notch, and a radially projecting leg, a first pawl and a second pawl, each pawl including a first arm position at a respective channel of the housing and a second arm selectively engageable with the disc, and at least one lock lever pivotably coupled to the housing, and wherein when the first connector is secured to the connector apparatus, the first connector is received within the first channel of the housing and the first notch of the disc such that the disc is rotated in a first position with the first connector disposed at a distal end of the first channel and the disc is rotationally locked with the locking mechanism with the second pawl engaged with the disc and the radially projecting leg is engaged with the at least one lock lever; inserting a second connector into the second notch and the second channel so that the second connector actuates the first arm of the second pawl to release the second pawl from engagement with the disc; actuating the at least one lock lever to release the radially projecting leg of the disc; and once the second pawl and the at least one lock lever are disengaged from the disc, rotating the disc towards a second position whereby the second connector moves and secures within a distal end of the second channel via the first pawl and the at least one lock lever while simultaneously the first connector moves and releases from the distal end of the first channel of the housing.

In an example, the locking mechanism further includes a biasing member supported within the housing, and the disc has a radially projecting lug engaged with the biasing member, and rotating the disc between the first position and the second position includes overcoming a spring force of the biasing member. In another example, the at least one lock lever includes a first lock lever and a second lock lever, the first lock lever engaged with the second lock lever, and actuating the at least one lock lever includes pivoting at least one of the first lock lever or the second lock lever from a locked position to an unlocked position. In yet another example, inserting the second connector into the second notch includes pivoting the first arm of the second pawl completely past the second notch of the disc to release the second pawl from the disc.

In another aspect, the technology relates to a connector apparatus including: a housing having a first end and an opposite second end defining a longitudinal axis, wherein the housing defines a first channel and a second channel; and a locking mechanism disposed at least partially within the housing and configured to secure a first connector to the housing while allowing a second connector to release the first connector and be simultaneously secured to the housing, the locking mechanism including: a disc having a first notch, a second notch, and a radially projecting leg, the disc rotatable around a rotation axis orthogonal to the longitudinal axis between at least a first position whereby the first notch is aligned with a first opening of the first channel and a second position whereby the second notch is aligned with a second opening of the second channel; a first pawl and a second pawl, each pawl having a first arm and a second arm, the first and second pawls oppositely pivotable between at least an engaged position whereby the second arm is engaged with the disc and a disengaged position whereby the second arm is disengaged from the disc; and at least one lock lever pivotable between at least an unlocked position whereby the at least one lock lever is released from the radially projecting leg and a locked position whereby the at least one lock lever is engaged with the radially projecting leg, wherein to release the first connector from the housing and simultaneously secure the second connector to the housing, the second connector is inserted into the second opening and the second notch to engage the first arm of the second pawl and move the second pawl towards the disengaged position, and additionally, the at least one lock lever is actuated towards the unlocked position, thereby allowing the disc to rotate towards the second position.

In an example, the at least one lock lever is mechanically independent from the first and second pawls.

It is to be understood that both the foregoing introduction and the following detailed description are exemplary and explanatory and are intended to provide further explanation of the invention as claimed.

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIG. 1 is a perspective view of an exemplary connector apparatus.

FIG. 2 is an exploded perspective view of a connector component of the connector apparatus shown in FIG. 1.

FIGS. 3 and 4 are perspective views of a disc of a locking mechanism of the connector component shown in FIG. 2.

FIGS. 5 and 6 are perspective views of a pawl of the locking mechanism of the connector component shown in FIG. 2.

FIGS. 7 and 8 are perspective views of lock levers of the locking mechanism of the connector component shown in FIG. 2.

FIG. 9 is an exploded, perspective view of a connector of the connector apparatus shown in FIG. 1.

FIG. 10 is a front view of the locking mechanism in a first locked configuration.

FIG. 11 is a front view of the locking mechanism moving out of the first locked configuration.

FIG. 12 is another front view of the locking mechanism moving out of the first locked configuration.

FIG. 13 is a front view of the locking mechanism moving into a second locked configuration.

FIG. 14 is a front view of the locking mechanism in the second locked configuration.

FIG. 15 is a flowchart illustrating an exemplary method of connecting to a connector apparatus.

FIG. 16 is a perspective view of another exemplary connector apparatus with a different housing configuration.

### DETAILED DESCRIPTION

This disclosure describes examples of a connector apparatus for use in aerial amusement activities, such as, but not limited to, climbing wall activities that use auto-belays. Although, the features of the connector apparatus described herein can also be used in any other line braking system (e.g., industrial or occupational descender devices, such as personnel, equipment, or training, recreational descender devices, such as conveyances, rides, trolleys, ziplining, free-fall devices, and the like) as required or desired. The connector apparatus provides various improvements for belay devices that facilitate user efficiencies and safety.

In the connector apparatus described herein, features are described that increase the performance of the device. For example, a same or similar connector may be used for both a user harness connection and an anchor connection. These connectors are economical so that they can be applied to harness fleets at climbing gyms, adventure parks, and the like. As such, a specialized key, which is a high wear component, is no longer needed to release the user harness connection. Additionally, the connector apparatus provides redundant safety features to increase performance. Accordingly, a high performing and more efficient connector apparatus is provided.

The connector apparatus includes a locking mechanism disposed at least partially within a housing. A first connector can be secured to the housing and only released when a second connector is being secured to the housing. As such, users of the connector apparatus are reduced or prevented from miss-connecting the harness to the auto-belay, thereby increasing safety. Additionally, users of the connector apparatus are reduced or prevented from releasing the line of the auto-belay prior to connecting or after finishing with the auto-belay, thereby reducing or preventing line retraction.

The locking mechanism includes a rotatable disk that is configured to secure the connector to the housing. The locking mechanism includes pivoting pawls that selectively engage the disk to prevent rotation thereof. The pawls are actuated by direct contact with the connectors so that is it is the receiving movement of one connector that simultaneously facilitates releasing the other connector. Additionally, the locking mechanism includes at least one lock lever that independently and separately selectively engage the disk to prevent rotation thereof. Accordingly, two separate disengagement actions that release the disc for rotation are needed by the locking mechanism. This facilitates security and provides a redundant system to reduce unintentional release during twisting of the connector apparatus. Also, the connector apparatus can include a biasing member engaged with the disc that prevents free rotation of the disc when the disc is moved between rotational positions. Many other features of the connector apparatus are described further below.

Throughout this description, references to orientation (e.g., front(ward), rear(ward), top, bottom, back, right, left, upper, lower, etc.) of the connector apparatus relate to its position when installed on an auto-bely and are used for ease of description and illustration only. No restriction is intended by use of the terms regardless of how the connector apparatus is situated on its own. As used herein, the terms “axial” and “longitudinal” refer to directions and orientations, which extend substantially parallel to a centerline of the component or system. Moreover, the terms “radial” and “radially” refer to directions and orientations, which extend substantially perpendicular to the centerline of the component or system. In addition, as used herein, the term “circumferential” and “circumferentially” refer to directions and orientations, which extend arcuately about the centerline of the component or system.

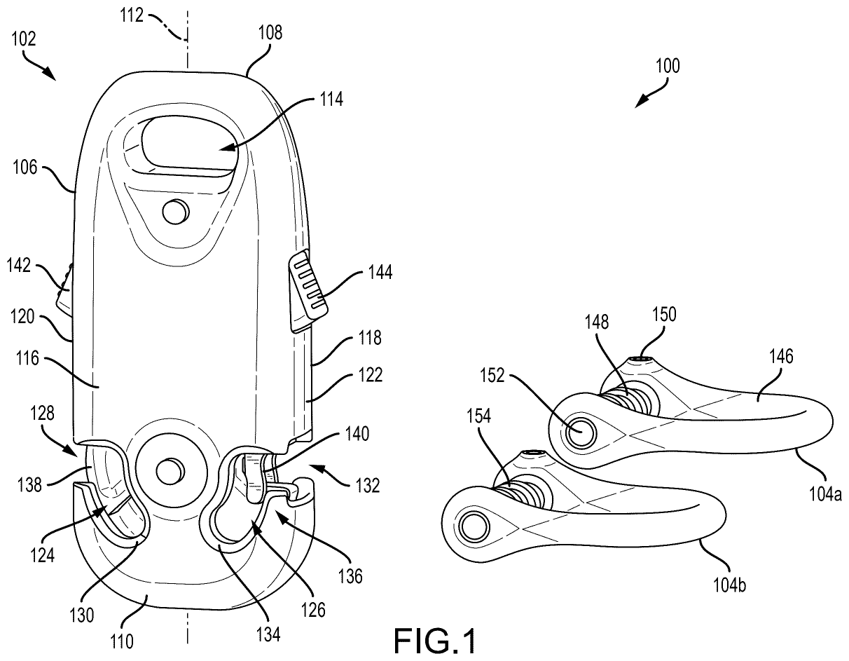

FIG. 1 is a perspective view of an exemplary connector apparatus 100. The connector apparatus 100 is configured to be used in aerial amusement actives (e.g., climbing walls, climbing structures, etc.) and climbing competitions. The connector apparatus 100 includes a connector component 102 and a plurality of connectors 104. The connector component 102 is configured to connect to a line of a line dispensing device (not shown) and so that a user (e.g., climber) with a harness can utilize the connector 104 to attach the harness to the line dispensing device. Additionally, the line of the line dispensing device can be anchored when not in use via the connector component 102 so that the line does not undesirably retract within the line dispensing device. The line dispensing device may be an auto-belay device used for climbing walls. Examples of auto-belays are the TRUBLUE iQ and TRUBLUE SPEED from TruBlue LLC d/b/a Head Rush Technologies. In other aspects, the connector apparatus 100 may be used for safety line activities such as workers at height and the like.

The connector component 102 includes a housing 106 with a first end 108 and an opposite second end 110. A longitudinal axis 112 is defined between the first end 108 and the second end 110. The first end 108 defines a through hole 114 configured to couple to the line dispensing device. In an example, a webbing component (not shown) is attached to the housing 106 via the through hole 114 at one end and the other end of the webbing component includes a swivel member that attaches to the line (e.g., webbing, rope, cable, etc.) of the line dispensing device. The swivel member allows the housing 106 to be freely rotatable relative to the line of the line dispensing device and facilitate operation of the line dispensing device (e.g., the retraction and extension of the line). In other examples, a swivel loop (not shown) may be rotatably coupled to the first end 108 of the housing 106. The swivel loop may be secured to the line of the line dispensing device and allow rotation therebetween. One example of a swivel loop is described in U.S. Patent Application Publication No. 2022/0341445 dated Oct. 27, 2022 and incorporated by reference herein in its entirety.

The housing 106 includes a first side 116, a second side 118, a first sidewall 120, and a second sidewall 122, such that the housing 106 is substantially rectangular in shape with the first side 116 and the second side 118 tapering towards each other at the first end 108. The shape and size of the housing 106 provides an ergonomic and identifiable grip for the user to assist with making the connection to the connector 104 as described herein and to facilitate ease of use for the user.

The housing 106 defines a first channel 124 and a second channel 126, both sized and shaped to receive a portion of the connector 104. The first channel 124 extends inward from an opening 128 on the first sidewall 120 to a distal end 130 within the housing 106 towards the second end 110. The second channel 126 also extends inward from an opening 132 on the second sidewall 122 to a distal end 134 within the housing 106 towards the second end 110. Both of the first channel 124 and the second channel 126 extend between the first side 116 and the second side 118 of the housing 106. In an aspect, the first channel 124 and the second channel 126 are symmetrical relative to the longitudinal axis 112.

The connector component 102 also includes a locking mechanism 136 that is configured to selectively secure the connector 104 to the housing 106 and within one of the first channel 124 or the second channel 126. More specifically, the locking mechanism 136 is configured to secure a first connector 104a to the housing 106 while allowing a second connector 104b to be used to release the first connector 104a and be concurrently secured to the housing 106. The locking mechanism 136 is disposed at least partially within the housing 106 proximate the second end 110 and adjacent the channels 124, 126. In the example, the locking mechanism 136 includes a rotatable disc 138 and a plurality of pawls 140 for selectively securing the connectors 104 within the first channel 124 or the second channel 126.

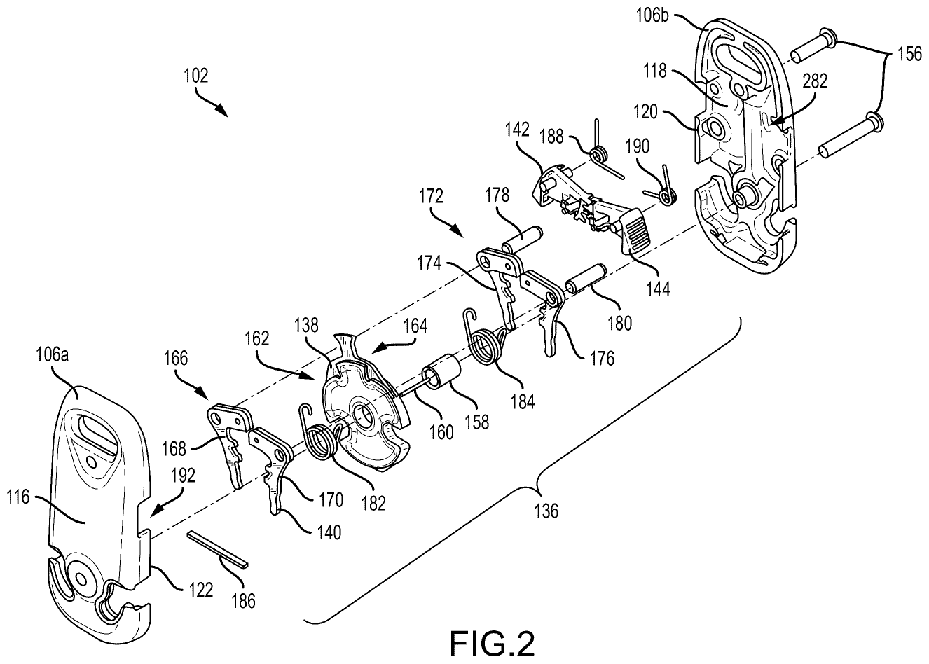

Additionally, the locking mechanism 136 includes a first lock lever 142 and a second lock lever 144. The first lock lever 142 is disposed on the first sidewall 120 and the second lock lever 144 is disposed on the second sidewall 122. The first lock lever 142 and the second lock lever 144 are disposed between the rotatable disc 138 and the first end 108 of the housing 106. The first and second lock levers 142 are independent from the plurality of pawls 140 and are used for restricting or locking rotational movement of the disc 138 unless actuated. The locking mechanism 136 is described further below in reference to FIGS. 2-14.

The first connector 104a includes a U-shaped body 146 and a pin 148. The first connector 104a is configured to be attached to a user's harness with the U-shaped body 146 and to removably couple to the connector component 102 at the pin 148. The pin 148 is secured to the U-shaped body 146 with a screw 150 at a head of the pin so that the pin 148 and the connectors 104 are not removable without the use of tools. In an aspect, a tail end 152 of the pin 148 may thread into the U-shaped body 146 as required or desired. The second connector 104b is configured to be attached to a ground wall anchor with the U-shaped body and to removably couple to the connector component 102 at the pin 148.

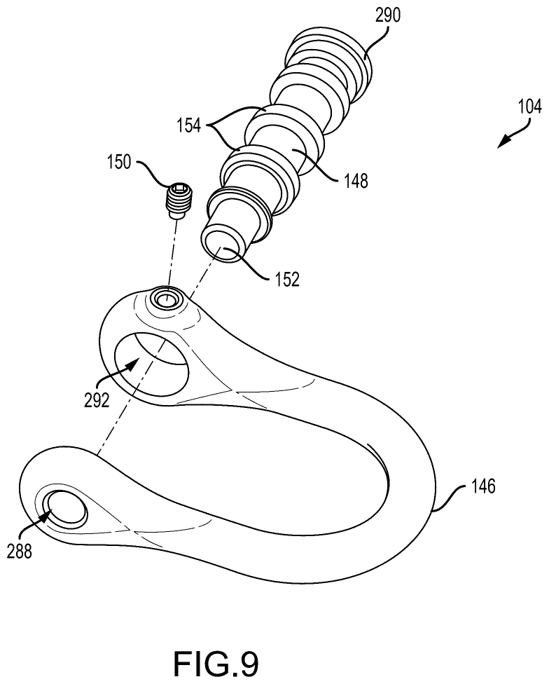

The connector apparatus 100 described herein uses two identical connectors 104 for operation. By having two connectors 104, the first connector 104a may be semi-permanently attached to a user's harness while the second connector 104b may be semi-permanently attached to a ground or wall anchor (e.g., via webbing or the like). By using a locking pin 148, the connector 104 is more securely attached to the harness and anchor, but can still be removed as required or desired. In an aspect, a tool (e.g., a screw driver) may be required to release the pin 148 so that a user cannot detach the connector 104 from the harness or anchor without use of the tool. The connectors 104 are described further below and in reference to FIG. 9.

The connector component 102 is configured to be secured to only one connector 104 at a time, and the other connector that is not connected, is used to release the secured connector 104 while simultaneously being captured and secure by the connector component 102 itself. As such, users of the connector apparatus 100 are reduced or prevented from miss-connecting the harness to the line dispensing device, thereby increasing safety. Additionally, users of the connector apparatus 100 are reduced or prevented from releasing the line of the line dispensing device prior to connecting or after finishing with the line dispensing device, thereby reducing or preventing line retraction. In operation, the connector 104 is a component that is cost effective to manufacture so that many connectors can be pre-attached to harness and to anchors for auto-belays.

In the example, the pin 148 of the connector 104 that couples to the connector component 102 may include one or more flange profiles 154 to assist with securing the connector 104 to the connector component 102. However, the flange profiles 154 are useable in both the first and second channels 124, 126, and thus, the flange profiles are not a unique key. Additionally, the flange profiles 154 are a highly wear resistant shape (e.g., a rectangular or square flange).

Both the first channel 124 and the second channel 126 have an arcuate shape. The arcuate shape of the channels 124, 126 are such that the connector 104 cannot merely linearly slide between the opening of the channel and the distal end thereof.

FIG. 2 is an exploded perspective view of the connector component 102 of the connector apparatus 100 (shown in FIG. 1). The connector component 102 includes a two piece housing 106a, 106b that houses the locking mechanism 136 and connects together with one or more fasteners 156 (e.g., rivets). The connector component 102 is load rated so that the user can be properly connected to the line dispensing device as described above.

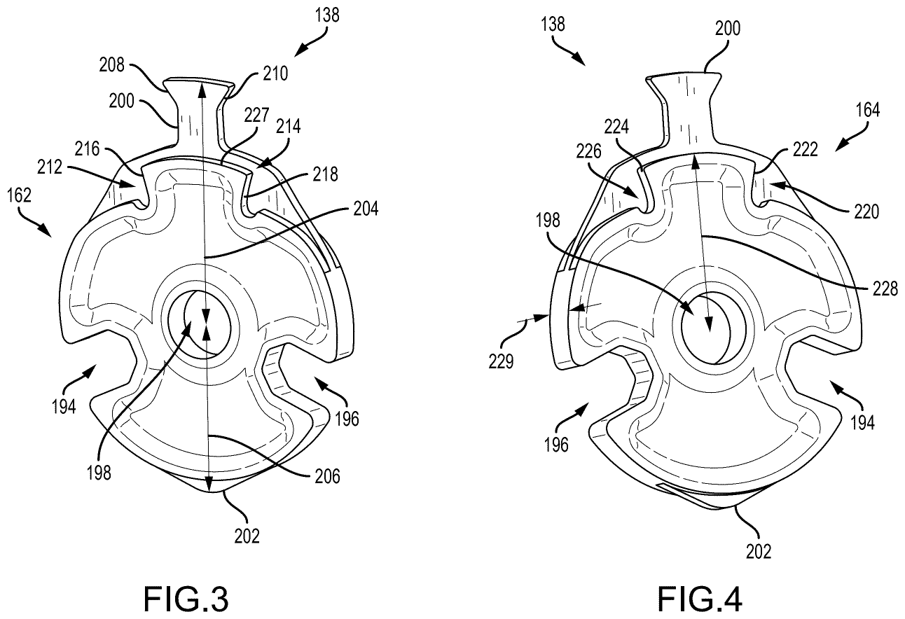

The locking mechanism 136 is supported at least partially within the housing 106 and includes the disc 138 that is rotatably mounted at least partially within the housing 106 at a sleeve bearing 158. The disc 138 is rotatable around a rotation axis 160 that is orthogonal to the longitudinal axis 112 (shown in FIG. 1). The disc 138 has a first side 162 the faces the housing piece 106a that defines the first side 116 and an opposite second side 164 that faces the housing piece 106b that defines the second side 118. The disc 138 being oriented parallel to the first and second sides 116, 118 of the housing 106. The disc 138 is described further below and in reference to FIGS. 3 and 4.

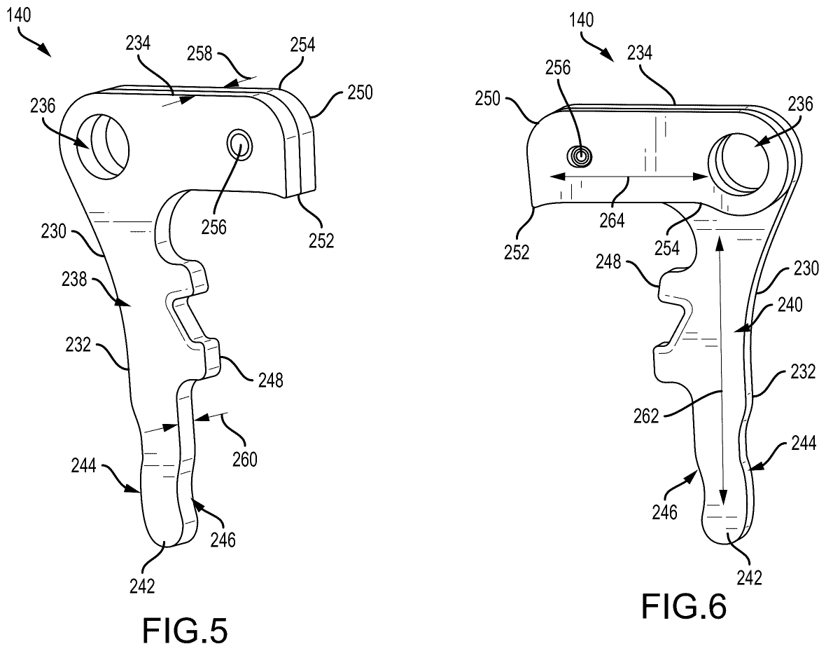

The plurality of pawls 140 are disposed on both sides 162, 164 of the disc 138. The plurality of pawls 140 include a first set 166 of a first pawl 168 and a second pawl 170 disposed on the first side 162 of the disc 138. Additionally, a second set 172 of a first pawl 174 and a second pawl 176 on the second side 164 of the disc 138. The first pawls 168, 174 are pivotably supported within the housing 106 by a first pivot pin 178. The second pawls 170, 176 are pivotably supported within the housing 106 by a second pivot pin 180. A first biasing member 182 biases the pivot position of the first set 166 of pawls and a second biasing member 184 biases the pivot position of the second set 172 of pawls. The biasing members 182, 184 are mounted on the sleeve bearing 158. In the example, the biasing members 182, 184 may be a torsion spring. In an aspect, each torsion spring may be a pair of torsion springs, one for the first pawl and one for the second pawl at each pawl set. In other examples, the first and second pawls may be combined into a single integral pawl with two ends, one end engaging with the disc at a time. In still other examples, the first and second pawls may be formed as a slider that slides linearly along the longitudinal axis to engage with the disc. The pawls 140 are described further below and in reference to FIGS. 5 and 6.

The second end 110 of the housing 106 supports a biasing member 186 that engages with the disc 138. In the example, the biasing member 186 may be a leaf spring configured to generate a spring force that the disc 138 must overcome when rotating around the rotation axis 160. In an aspect, the biasing member 186 is disposed below the disc 138 and within an interior cavity of the housing 106.

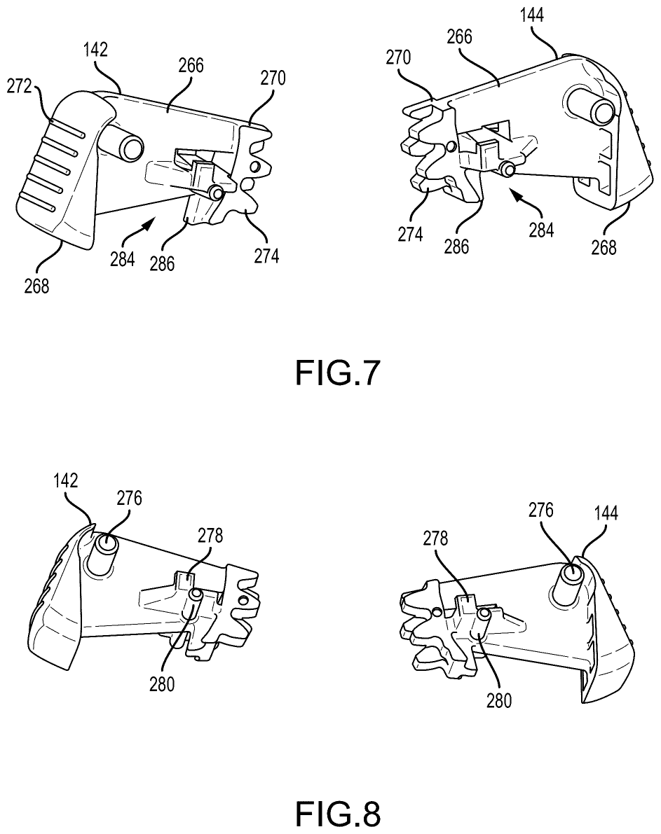

The first and second lock levers 142, 144 are also pivotably coupled within the housing 106. A first biasing member 188 biases the pivot position of the first lock lever 142 and a second biasing member 190 biases the pivot position of the second lock lever 144. In the example, the biasing members 188, 190 may be a torsion spring. Each housing piece 106a, 106b defines a cavity 192 at each of the first and second sidewalls 120, 122. When the housing 106 is coupled together, the corresponding cavities 192 form a passage through the housing 106 that at least a portion of the first and second lock levers 142, 144 project through. The lock levers 142, 144 are described further below and in reference to FIGS. 7 and 8.

FIGS. 3 and 4 are perspective views of the disc 138. FIG. 3 illustrates the first side 162 of the disc 138 and FIG. 4 illustrates the second side 164 of the disc 138. Referring concurrently to FIGS. 3 and 4, the first side 162 may be axially symmetrically to the second side 164. The disc 138 defines a first notch 194 and a second notch 196 defined in its outer perimeter and through the first and second sides 162, 164. The notches 194, 196 extend radially inwards within the disc 138 towards an aperture 198 that mounts over the sleeve bearing 158 (shown in FIG. 2). The notches 194, 196 are sized and shaped to at least partially receive the connectors 104 (shown in FIG. 1). The notches 194, 196 may be substantially U-shaped. In the example, the notches 194, 196 are spaced about 120° apart from each other. This configuration enables for the second notch 196 to be aligned with the opening 132 of the second channel 126 and the first notch 194 to be aligned with the distal end 130 of the first channel 124, while conversely, when the first notch 194 is aligned with the opening 128 of the first channel 124, the second notch 196 is aligned with the distal end 134 of the second channel 126 (the openings and channels shown in FIG. 1).

The disc 138 also includes a radially projecting leg 200 and a radially projecting lug 202. The radially projecting leg 200 is opposite the radially projecting lug 202 on the disc 138, and both the leg and the lug are axially centered on the disc 138. In the example, the radially projecting leg 200 has an extension length 204 defined from a center of the disc 138 that is greater than an extension length 206 of the radially projecting lug 202. The radially projecting leg 200 has a T-shaped distal end with a first oblique surface 208 and a second oblique surface 210. The radially projecting leg 200 is configured to selectively engage with the first and second lock levers 142, 144 (shown in FIG. 2). More specifically, the oblique surfaces 208, 210 form radial stop surfaces for engaging with the lock levers 142, 144 for restricting or preventing rotation of the disc 138. The radially projecting lug 202 is a curved lug that is configured to engage with the biasing member 186 (shown in FIG. 2). In the example, both the radially projecting leg and lug 200, 202 are circumferentially centered between the first and second notches 194, 196.

The disc 138 also defines a plurality of shoulders 212 that are configured to engage with the pawls 140 (shown in FIG. 2). The disc 138 defines a first set 214 of shoulders with a first shoulder 216 and a second shoulder 218 on the first side 162 of the disc 138. Additionally, a second set 220 of shoulders with a first shoulder 222 and a second shoulder 224 are on the second side 164 of the disc 138. The shoulders 212 define a radial stop surface for engaging with the pawls 140 for restricting or preventing rotation of the disc 138. In the example, a groove 226 may be defined on the shoulders 212 for engagement with the nose of the pawls 140. The shoulders 212 are positioned on the disc 138 at a distance 228 from the center that is greater than the extension length 206 of the radially projecting lug 202 and smaller than the extension length 204 of the radially projecting leg 200. The shoulders 212 are also connected by a circumferential section 227.

The shoulders 212 are axially offset from the radially projecting leg 200 and the radially projecting leg 200 is disposed between the first and second sets 214, 220 of the shoulders. As such, the disc 138 has an axial thickness 229 defined between the first and second sides 162, 164, and the radially projecting leg 200 and radially projecting lug 202 are centered within the thickness 229 while having a smaller thicknesses. This configuration also has the thickness of the shoulders 212 having a smaller thickness than the overall thickness 229 of the disc 138. In some examples, the first side 162 or the second side 164 of the disc 138 may be partially recessed to facilitate manufacturing.

FIGS. 5 and 6 are perspective views of the pawl 140. While the first pawl 168 from the first set 166 of pawls is illustrated, it is appreciated that the second pawl 170 has a mirrored configuration, while the second set 172 are pawls are mirrored to the first set (all shown in FIG. 2). Referring concurrently to FIGS. 5 and 6, the pawl 140 is formed from a substantially L-shaped body 230 having a first arm 232 and a second arm 234. At the intersection of the first arm 232 and the second arm 234, a hole 236 is defined to receive the pivot pin 178, 180 (shown in FIG. 2). The body 230 has a first side 238 that faces the housing 106 (shown in FIG. 2) and an opposite second side 240 that faces the disc 138 (shown in FIGS. 3 and 4).

A distal end 242 of the first arm 232 is configured to be positioned proximate the openings 128, 132 of the first and second channels 124, 126 defining in the housing 106 (all shown in FIG. 1). An outer surface 244 of the first arm 232 is configured to directly contact the connectors 104 such that the pawl 140 is pivotable around the pivot pin 178, 180 upon actuation from the connectors 104. In an aspect, at least a portion of the outer surface 244 is concave and corresponds to the shape of the flange profiles 154 of the connector 104 (shown in FIG. 1). An inner surface 246 of the first arm 232 includes one or more spring supports 248 so that the pawl 140 is coupled to the biasing member 182, 184 (shown in FIG. 2).

A distal end 250 of the second arm 234 is configured to selectively engage the shoulders 212 of the disc 138 (shown in FIGS. 3 and 4). The distal end 250 may include a toothed nose 252 projecting therefrom. A secondary plate 254 is coupled to the second arm 234 with a pin 256. As such, a thickness 258 of the second arm 234 is greater than a thickness 260 of the first arm 232. This configuration enables the first arm 232 to be at least partially positioned axially over the disc 138, while the second arm 234 is able to selectively engage the shoulders 212 that are defined within the disc 138. In the example, the first arm 232 has a length 262 that is longer than a length 264 than the second arm 234.

As illustrated in FIGS. 5 and 6, the pawl 140 is formed via two pieces of stamped metal. In other examples, the pawl 140 may be a one piece CNC'd metal component such that the body and the secondary plate are integrated with one another and for a solid component.

FIGS. 7 and 8 are perspective views of the first and second lock levers 142, 144. Referring concurrently to FIGS. 7 and 8, the first and second lock levers 142, 144 are identical components that are coupled back-to-back to one another. The lock levers 142, 144 have a body 266 defining an outer end 268 and an opposite inner end 270. The outer end 268 is configured to extend out of the housing 106 (shown in FIG. 1) and forms a lever or button like shape for manual actuation by the user. In the example, the outer end 268 is a substantially triangular shape with an outer face having one or more ridges 272 for the user. The inner end 270 is positioned within the housing 106 and forms one or more teeth 274 so that the first and second lock levers 142, 144 operationally engage with each other. The teeth 274 on the inner end 270 of the first lock lever 142 are meshed with the teeth 274 on the inner end 270 of the second lock lever 144.

Proximate the outer end 268, the lock levers 142, 144 define a pivot pin 276 that engages with the housing 106 and that forms the pivot point for the lock levers 141, 144. Because the inner ends 270 of the lock levers 142, 144 are engaged, pivoting movement of one lock lever 142 can result in pivoting movement of the other lock lever 144 and so that the user does not necessarily have to actuate both lock lever 142, 144 simultaneously. Proximate the inner end 270, the lock levers 142, 144 defines an outwardly projecting seat 278. The seat 278 is configured to engage with the biasing members 188, 190 so that the lock levers 142, 144 are biased around the pivot pin 276. A post 280 is also defined proximate the seat 278. The post 280 is configured to ride at least partially within a groove 282 (shown in FIG. 2) defined within the interior cavity of the housing 106 and to at least partially define the pivoting movement of the lock levers 142, 144.

Additionally, the bottom of the body 266 of the lock levers 142, 144 defines a recess 284 with an oblique surface 286 disposed at the inner end 270. The recess 284 is configured to receive at least a portion of the radially projecting leg 200 of the disc 138 (both shown in FIGS. 3-4) and so that the lock levers 142, 144 provide a rotational stop to the disc 138.

FIG. 9 is an exploded, perspective view of the connector 104. The U-shaped body 146 is configured to receive the pin 148 and the pin 148 is secured with the set screw 150. The pin 148 includes the tail end 152 that threads into engagement with a threaded aperture 288 at one end of the U-shaped body 146. A head end 290 of the pin 148 extends through a larger aperture 292 at the other end of the U-shaped body 146 and includes a groove that at least partially receives the set screw 150. The pin 148 includes a pair of flange profiles 154 that extends all the way around the pin 148. The flange profiles 154 are spaced apart from each other. The flange profiles 154 are configured to engage with the pawls 140 (shown in FIGS. 5 and 6) so as to actuate the pawls. It is appreciated that other types of connectors, such as, but not limited to, maillon connectors, locking carabiners or hooks, and the like, may be used that facilitate operation of the connector apparatus 100 (shown in FIG. 1) and as described herein. The connector 104 may be generally referred to as a shackle connector, a key link connector, a quick link connector, a maillon connector, or the like.

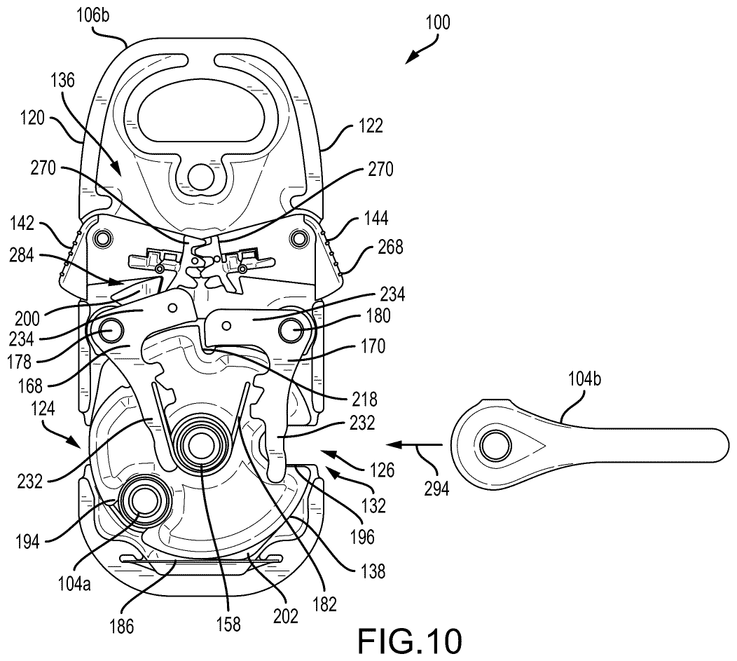

FIG. 10 is a front view of the locking mechanism 136 in a first locked configuration. As illustrated in FIG. 10, the housing piece 106a (shown in FIG. 2) is removed for clarity. In the first locked configuration, the disc 138 is rotated in a first rotation position around the rotation axis 160 (shown in FIG. 2) such that the radially projecting leg 200 is positioned towards the first sidewall 120 and the first notch 194 is positioned at the distal end 130 (shown in FIG. 1) of the first channel 124 of the housing 106. When the disc 138 is in the first rotation position, the first connector 104a (shown with only the pin) is securely captured within the first channel 124 of the housing 106 via the disc 138. The disc 138 is rotationally locked in the first rotation position via the locking mechanism 136. The second pawls 170, 176 (176 not visible) are engaged with the disc 138. Additionally, the radially projecting leg 200 of the disc 138 is engaged with the first lock lever 142 and the radially projecting lug 202 of the disc 138 is engaged with the biasing member 186.

The second arm 234 of the second pawl 170 is engaged with the second shoulder 218 of the disc 138 and so as to rotationally lock the disc 138 in the first rotation position within the housing 106. The second pawl 170 prevents the disc 138 from rotating in the clockwise direction in FIG. 10, while the connector 104a being at the distal end 130 of the first channel 124 and against the housing 106 prevents the disc 138 from rotating in the counter-clockwise direction. The pawls 140 (shown in FIGS. 5 and 6) are configured to pivot around the pivot pins 178, 180 between at least an engaged position and a disengaged position with regards to the disc 138. In the first locked configuration, the first pawls 168, 174 (174 not visible) are in the disengaged position whereby the second arm 234 is disengaged with the first shoulder 216 (shown in FIG. 3). In the disengaged position, the second arm 234 is disposed radially outside of the first shoulder 216 with the first arm 232 pivoted towards the sleeve bearing 158 and inside of the first connector 104a. In an aspect, the secondary plate 254 (shown in FIGS. 5 and 6) of the second arm 234 of the first pawls 168, 174 is in the same plane as the shoulders 216, 218 and rides on top of the shoulders at the circumferential portion.

The second pawls 170, 176, however, are in the opposite position of the first pawls 168, 174 and in the engaged position with the disc 138. The biasing members 182, 184 (184 not visible) bias the pawls 140 toward the engaged position. In the engaged position, the second arm 234 is disposed in the radial plane of the second shoulder 218 with the first arm 232 pivoted away from the sleeve bearing 158 and at least partially extending adjacent the second notch 196 of the disc 138 and the opening 132 of the second channel 126.

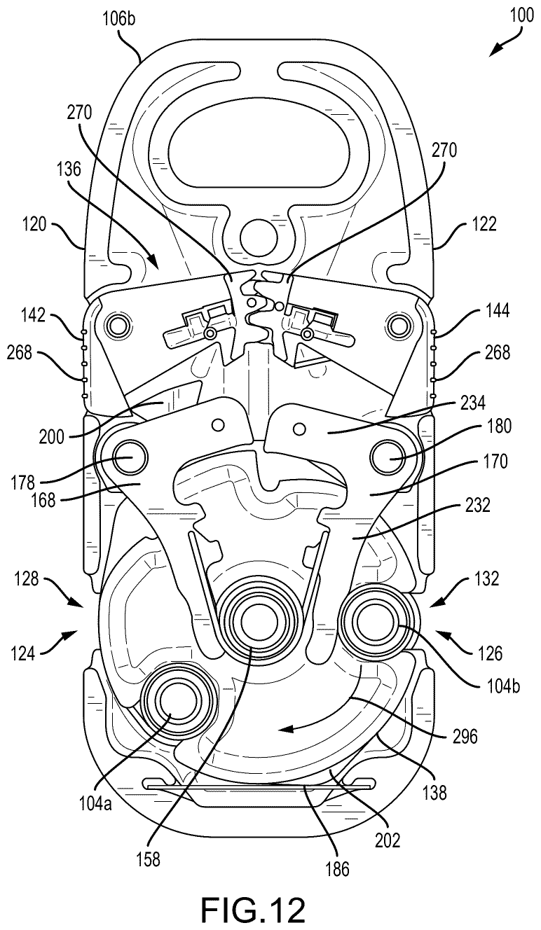

In addition to the second pawls 170, 176 engaging the disc 138 in the first rotation position, rotation of the disc 138 out of the first rotation position is restricted or prevented by the radially projecting leg 200 engaged with the first lock lever 142. The first and second lock levers 142, 144 are pivotable between at least a locked position and an unlocked position (shown in FIG. 12) with regards to the disc 138. Both of the lock levers 142, 144 are shown in the locked position in FIG. 10 and the lock levers 142, 144 are biased towards the locked position via the biasing members 188, 190 (shown in FIG. 2). In the locked position, the inner ends 270 of the lock levers 142, 144 are posited towards the sleeve bearing 158 such that the radially projecting leg 200 is received within the recess 284 of the first lock lever 142. As such, the first lock lever 142 restricts or prevents the disc 138 from rotating out of the first rotation position in the clockwise direction unless the lock levers 142, 144 are moved towards the unlocked position and as described further below. In the locked position, the outer ends 268 of the lock levers 142, 144 project outwards from sidewalls 120, 122 of the housing 106.

Furthermore, the biasing member 186 is supported within the housing 106 such that it is engaged with the radially projecting lug 202 of the disc 138 and restricts or prevents clockwise movement of the disc 138. When the disc 138 is in the first rotation position, the spring force of the biasing member 186 captures the lug 202 between the biasing member 186 and the housing 106 so that the disc 138 is restricted or prevented from being rotated unless the spring force is overcome (e.g., utilizing the lug 202 to deflect the biasing member 186 in the housing 106).

When the locking mechanism 136 is in the first locked configuration and rotationally locks the disc 138 in the first rotation position, the second notch 196 of the disc 138 is positioned at the opening 132 of the second channel 126. Accordingly, the connector apparatus 100 is configured to be able to receive 294 the second connector 104b so that the first connector 104a can be released from the housing 106 via activation by the second connector 104b. In the example, the second connector 104b is configured to directly contact at least a portion of the locking mechanism 136 when the disc 138 is in the first rotation position.

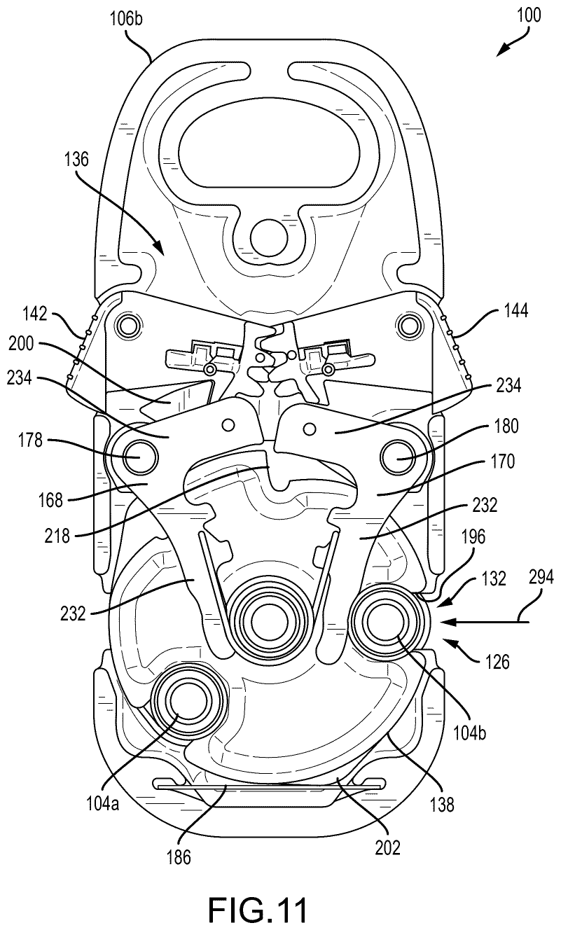

FIG. 11 is a front view of the locking mechanism 136 moving out of the first locked configuration. FIG. 12 is another front view of the locking mechanism 136 moving out of the first locked configuration. Starting first with FIG. 11, the second connector 104b (shown only with the pin) is moved 294 into the second notch 196 of the disc 138 and the opening 132 of the second channel 126. This movement of the second connector 104b contacts the first arm 232 of the second pawls 170, 176 (176 not visible) so as to pivot the second pawls 170, 176 around the pivot pin 180 into the disengaged position whereby the second arm 234 is moved out of engagement with the second shoulder 218. In the example, the flange profiles 154 (shown in FIG. 9) of the second connector 104b directly contact the second pawls 170, 176 so that the first arm 232 completely pivots past the second notch 196 with the shaft of the pin being within the second notch 196. Accordingly, a pin without the flanged profiles may not be able to pivot the pawl completely into the disengaged position.

Once the second pawls 170, 176 are disengaged from the disc 138 via the second connector 104b, the first pawls 168, 174 (174 not visible) remain in the disengaged position as the second arm 234 rides on top of the shoulder 218. This configuration of the pawls 140 (shown in FIGS. 5 and 6) releases the rotational lock of the pawls 140 from the disc 138. However, the locking mechanism 136 does not completely release the disc 138 upon disengagement with the pawls 140 and the disc 138 is not free to rotate around the rotation axis 160 (shown in FIG. 2). Rather, the radially projecting leg 200 of the disc 138 is still engaged with the first lock lever 142 and the lock levers 142, 144 are in the locked position. Additionally, the radially projecting lug 202 of the disc 138 is still engaged between the biasing member 186 and the housing 106. The engagement between the disc 138 and the lock lever 142 and the disc 138 and the biasing member 186 restricts or prevents rotation of the disc 138 around the rotation axis 160 and requires an additional release action by the user on top of the insertion of the second connector 104b. In this example, this additional release action is via the first and second lock levers 142, 144.

Turning now to FIG. 12, the second pawls 170, 176 remain in the disengaged position due to the position of the second connector 104b. Furthermore, the user manually actuates the first and second lock levers 142, 144 to pivot the lock levers 142, 144 from the locked position to the illustrated unlocked position. In the unlocked position, the inner ends 270 of the lock levers 142, 144 are pivoted away from the sleeve bearing 158 and by pressing the outer ends 268 of the lock levers 142, 144 inwards towards the sidewalls 120, 122. In the example, the inner ends 270 of the lock levers 142, 144 are engaged with each other via the teeth 274 (shown in FIGS. 7 and 8) so that the user does not necessarily have to actuate both lock levers 142, 144 simultaneously. Rather, movement of one lock lever drives corresponding movement to the other lock lever. When the first lock lever 142 is in the unlocked position, the first lock lever 142 disengages with the radially projecting leg 200 of the disc 138.

The lock levers 142, 144 are mechanically independent from the pawls 140 such that to disengage the lock levers 142, 144 from the disc 138 requires a different actuation than merely disengaging the pawls 140 from the disc 138 with the connector 104b.

When the lock levers 142, 144 are in the unlocked position via the user manually overcoming the biasing members 188, 190 (shown in FIG. 2), the locking mechanism 136 does not completely release the disc 138 and the disc 138 is not free to rotate around the rotation axis 160. Rather, the radially projecting lug 202 of the disc 138 is still engaged between the biasing member 186 and the housing 106. The engagement between the biasing member 186 restricts or prevents rotation of the disc 138 around the rotation axis 160 and requires the user overcoming the spring force of the biasing member 186 when rotating 296 the disc 138 with the second connector 104b.

By including a redundant locking mechanism system, performance and safety of the connector apparatus 100 is facilitated even when the user is twisting and falling when attached to the auto-belay. For example, having two sets of pawls 140 provides a redundant locking system for the disc 138. Further, having both the lock levers 142, 142 and the pawls 140 needing to be independently released provides a more deliberate release action for the user. Additionally, the biasing member 186 reduces the disc 138 from undesirably freely rotating around the rotation axis 160.

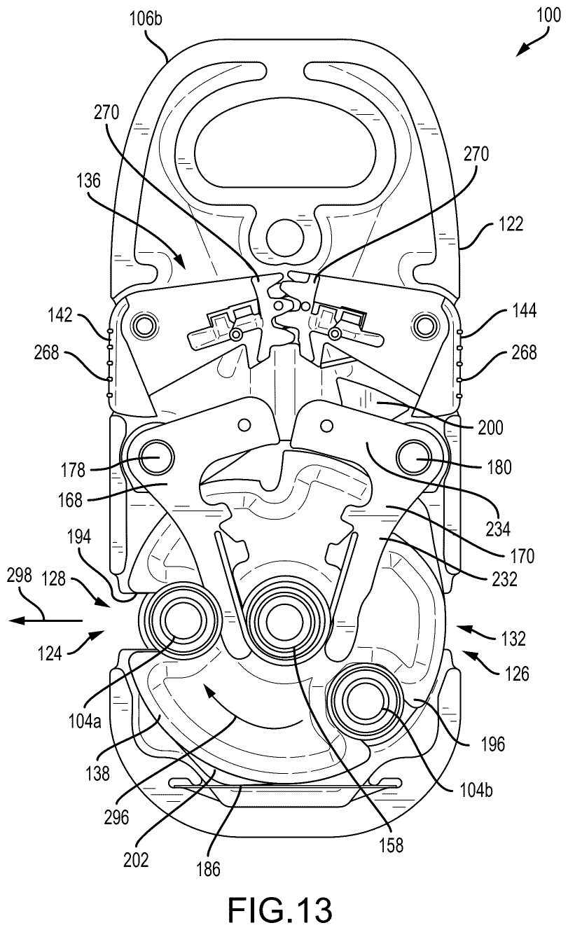

FIG. 13 is a front view of the locking mechanism 136 moving into a second locked configuration. From a first rotation position of the disc 138 (shown in FIGS. 10-12), the user rotates 296 the disc 138 into a second rotation position of the disc 138 by overcoming the spring force of the biasing member 186 and deflecting the spring with the radially projecting lug 202. In the second rotation position, the disc 138 is rotated around the rotation axis 160 (shown in FIG. 2) such that the radially projecting leg 200 is positioned towards the second sidewall 122 and the second notch 196 is positioned at the distal end 134 (shown in FIG. 1) of the second channel 126 of the housing 106 and away from the opening 132. When the disc 138 is in the second rotation position, the second connector 104b (shown with only the pin) is within the second channel 126 of the housing 106 and the second notch 196 of the disc 138, while the first connector 104a (also shown with only the pin) is moved towards the opening 128 of the first channel 124 of the housing 106 and within the first notch 194 of the disc 138. The first connector 104a is then enabled to be removed 298 from the connector apparatus 100.

Additionally, the radially projecting lug 202 of the disc 138 is captured between the biasing member 186 and the housing 106 at the opposite end and so that free rotation of the disc 138 out of the second rotation position is restricted or prevented. In the example, the connectors 104 are used to rotate the disc 138 towards the second rotation position once the pawls 140 are disengaged from the disc 138. The user also maintains the lock levers 142, 144 in the unlocked position so as to enable rotation of the disc 138 and clearance from the radially projecting leg 200.

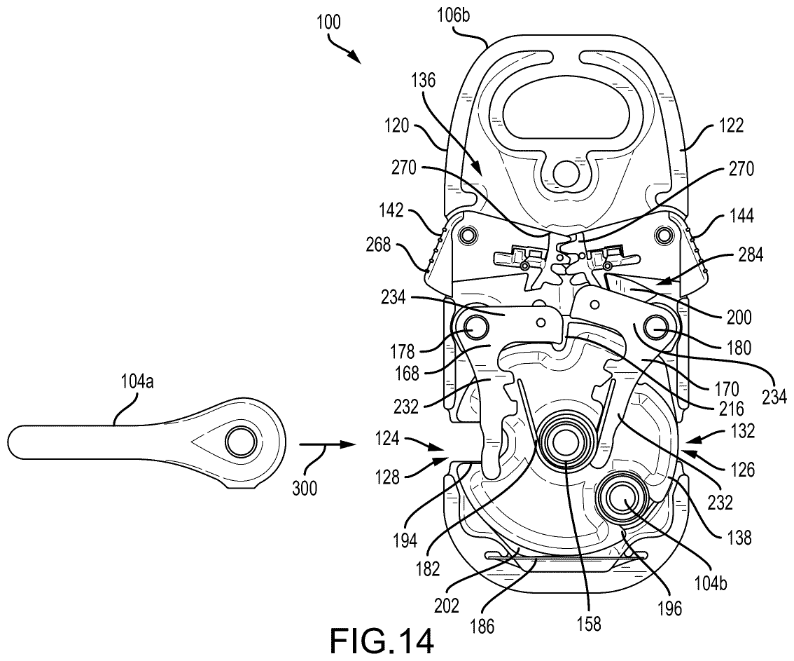

FIG. 14 is a front view of the locking mechanism 136 in the second locked configuration. In the second locked configuration, the disc 138 is rotationally locked in the second rotation position around the rotation axis 160 (shown in FIG. 2). When the disc 138 is in the second rotation position, the second connector 104b (shown with only the pin) is securely captured within the second channel 126 of the housing 106 via the disc 138. The disc 138 is rotationally locked in the second rotation position via the locking mechanism 136. The first pawls 168, 174 (174 not visible) are engaged with the disc 138. Additionally, the radially projecting leg 200 of the disc 138 is engaged with the second lock lever 144 and the radially projecting lug 202 of the disc 138 is engaged with the biasing member 186. In the example, when the first connector 104a is removed from the housing 106 and the lock levers 142, 144 are released, the locking mechanism 136 automatically returns to the locked configuration via the biasing members.

The second arm 234 of the first pawls 168, 174 are engaged with the first shoulder 216 of the disc 138 and so as to rotationally lock the disc 138 in the second rotation position within the housing 106. The first pawls 168, 174 prevent the disc 138 from rotating in the counter-clockwise direction in FIG. 14, while the second connector 104b being at the distal end 134 of the second channel 126 and against the housing 106 prevents the disc 138 from rotating in the clockwise direction. In the second locked configuration, the second pawls 170, 176 (176 not visible) are in the disengaged position. The first pawls 168, 174, however, are in the opposite position of the second pawls 170, 176 and in the engaged position with the disc 138.

In addition to the first pawls 168, 174 engaging the disc 138 in the second rotation position, rotation of the disc 138 out of the second rotation position is restricted or prevented by the radially projecting leg 200 engaged with the second lock lever 144. The first and second lock levers 142, 144 are pivoted towards the locked position with the inner ends 270 of the lock levers 142, 144 posited towards the sleeve bearing 158 such that the radially projecting leg 200 is received within the recess 284 of the second lock lever 144. In the locked position, the outer ends 268 of the lock levers 142, 144 project outwards from sidewalls 120, 122 of the housing 106.

Furthermore, when the disc 138 is in the second rotation position, the spring force of the biasing member 186 captures the lug 202 between the biasing member 186 and the housing 106 so that the disc 138 is restricted or prevented from being rotated unless the spring force is overcome (e.g., utilizing the lug 202 to deflect the biasing member 186 in the housing 106).

When the locking mechanism 136 is in the second locked configuration and rotationally locks the disc 138 in the second rotation position, the first notch 194 of the disc 138 is positioned at the opening 128 of the first channel 124. Accordingly, the connector apparatus 100 is configured to be able to receive 300 the first connector 104a so that the second connector 104b can be released from the housing 106 via activation by the first connector 104a. This actuation occurs in reverse of the above-described steps. In the example, the first connector 104a is configured to directly contact at least a portion of the locking mechanism 136 when the disc 138 is in the second rotation position.

While three rotational stop features (e.g., pawls 140, lock levers 142, 144, and biasing member 186) are described herein that restrict or prevent rotation of the disc 138 and secure the connector 104 to the housing 106, it should be appreciated that all three rotational stop features can be used independently from one another or in addition to each other. Furthermore, two of the three rotational stop features can be used with each other as required or desired.

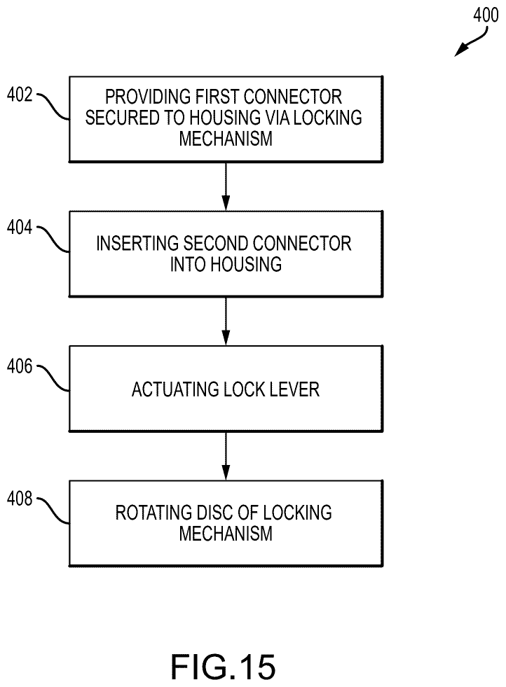

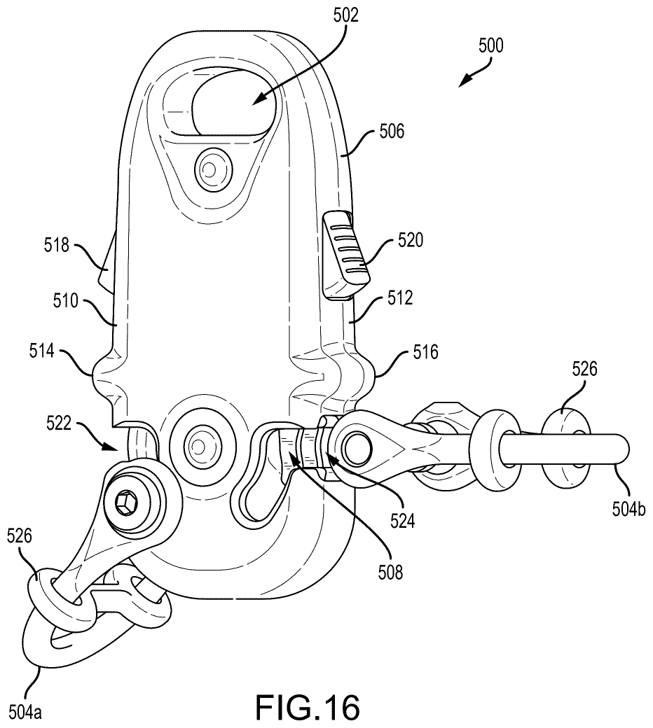

FIG. 15 is a flowchart illustrating an exemplary method 400 of connecting to a connector apparatus. The connector apparatus may be the same or similar to the connector apparatus 100 described above in reference to FIGS. 1-14 and the connector apparatus 50 described below in reference to FIG. 16. In the example, the connector apparatus includes a housing and a locking mechanism disposed at least partially within the housing. The housing has a first end and an opposite second end defining a longitudinal axis. The first end of the housing is configured to couple to a line dispensing device such as an auto-bely for climbing. The housing defines a first channel and a second channel for receiving connectors. The locking mechanism includes a disc rotatable around a rotation axis orthogonal to the longitudinal axis. The disc has a first notch, a second notch, and a radially projecting leg. The locking mechanism also includes a first pawl, a second pawl, and at least one lock lever pivotably coupled to the housing. Each pawl includes a first arm positioned at a respective channel of the housing and a second arm selectively engageable with the disc.

The method 400 begins with providing a first connector secured to the connector apparatus (operation 402). The first connector is secured to the connector apparatus such that the first connector is received within the first channel of the housing and the first notch of the disc with the disc is rotated in a first position. In the first position, the first connector is disposed at a distal end of the first channel and the disc is rotationally locked with the locking mechanism with the second pawl engaged with the disc and the radially projecting leg is engaged with the at least one lock lever.

A second connector is inserted into the second notch of the disc and the second channel of the housing (operation 404). When the second connector is inserted, the second connector directly contacts and actuates the first arm of the second pawl to release the second pawl from engagement with the disc. In an example, when the second connector is inserted into the second notch, the second connector contacts with a flanged profile the first arm of the second pawl so that the second pawl pivots completely past the second notch of the disc to disengage the second pawl from the disc.

Additionally, the at least one lock lever is actuated to release the radially projecting leg of the disc (operation 406). In the example, actuating the at least one lock lever includes manually pivoting the lock lever from a locked position towards an unlocked position relative to the housing. The at least one lock lever may include first and second lock levers that are operationally coupled together such that pivoting one lever results in the other lever pivoting. In other examples, actuating the at least one lock lever may include manually pressing or sliding a button as required or desired.

Once the second pawl and the at least one lock lever are disengaged from the disc, the disc is rotated towards a second position whereby the second connector moves and secures within a distal end of the second channel via the first pawl and the at least one lock lever, while simultaneously the first connector moves and releases from the distal end of the first channel of the housing (operation 408).

In an example, the locking mechanism further includes a biasing member supported within the housing and the disc has a radially projecting lug engaged with the biasing member. Rotating the disc from the first position towards the second position in operation 408 may further include overcoming a spring force of the biasing member. As such, when the pawls and the locking lever are disengaged from the disc, the disc is not freely rotatable around its rotational axis.

FIG. 16 is a perspective view of another exemplary connector apparatus 500 with a different housing configuration. The connector apparatus 500 is similar to the apparatus described above and is configured to couple to a line dispensing device via a through hole 502. Additionally, a housing 506 is configured to selectively couple to one of two connectors 504 while the other connector is used to release the coupled connector via a locking mechanism 508. In this example, however, each sidewall 510, 512 of the housing 506 includes an integral bump 514, 516. The bumps 514, 516 are disposed between lock levers 518, 520 and openings 522, 524 that are configured to receive the connectors 504. The bumps 514, 516 aid the user's grip when holding the housing 506 against the auto belay retraction and facilitate the user holding the housing 506 without covering the openings 522, 524. In an aspect, the bumps 514, 516 are symmetrical relative to a longitudinal axis of the housing 506. In other examples, each of the bumps 514, 516 may have different size, shape, or position so as to facilitate right or left handed grips.

Additionally, the connectors 504 may include a cross bar 526 that extends across the U-shaped body. The cross bars 526 restrict or prevent the webbing that the connectors 504 are attached to from sliding towards the pin and interfering with the coupling connection with the housing 506 and locking mechanism 508.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In this regard, any number of the features of the different embodiments described herein may be combined into one single embodiment and alternate embodiments having fewer than or more than all of the features herein described are possible. It is to be understood that terminology employed herein is used for the purpose of describing particular examples only and is not intended to be limiting. It must be noted that, as used in this specification, the singular forms “a,” “an,” and “the” include plural referents unless the context clearly dictates otherwise.

References in the specification to “one example,” “an example,” “an illustrative example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). Moreover, one having skill in the art will understand the degree to which terms such as “about,” “approximately,” or “substantially” convey in light of the measurement techniques utilized herein. To the extent such terms may not be clearly defined or understood by one having skill in the art, the term “about” shall mean plus or minus ten percent.

While various embodiments have been described for purposes of this disclosure, various changes and modifications may readily suggest themselves to those skilled in the art and may be made which are well within the scope of the present disclosure.

What is claimed is:

1. A connector apparatus comprising:
a housing having a first end and an opposite second end defining a longitudinal axis, the first end configured to couple to a line dispensing device, wherein the housing defines a first channel and a second channel each sized and shaped to receive at least a portion of a connector; and
a locking mechanism disposed at least partially within the housing, the locking mechanism including:
a disc rotatable around a rotation axis orthogonal to the longitudinal axis between at least a first position and a second position, the disc having a first notch and a second notch each sized and shaped to receive at least a portion of the connector, the disc also having a radially projecting leg;
a first pawl and a second pawl, each pawl including a first arm positioned at a respective channel of the housing and a second arm selectively engageable with the disc; and
at least one lock lever pivotably coupled to the housing,
wherein the locking mechanism secures the connector to the housing when the connector is positioned at a distal end of the first channel and within the first notch such that the disc is in the first position, the disc is rotationally locked with the locking mechanism with the second pawl engaged with the disc and the radially projecting leg is engaged with the at least one lock lever, and wherein when a second connector is inserted into the second channel and the second notch, the second connector actuates the first arm of the second pawl to disengage the second pawl from the disc, additionally, when the at least one lock lever is actuated, the at least one lock lever disengages the radially projecting leg, thereby allowing the second connector to move and rotate the disc for securing within a distal end of the second channel via the first pawl and the at least one lock lever while simultaneously allowing the connector to release from the distal end of the first channel during rotation of the disc towards the second position.

2. The connector apparatus of claim 1, wherein the locking mechanism further includes a biasing member supported within the housing, and the disc has a radially projecting lug engaged with the biasing member, and wherein a spring force of the biasing member is overcome in order to rotate the disc between the first position and the second position.

3. The connector apparatus of claim 2, wherein the radially projecting lug is opposite from the radially projecting leg on the disc.

4. The connector apparatus of claim 1, wherein the at least one lock lever includes a first lock lever and a second lock lever, the first lock lever and the second lock lever each pivotable between at least an unlocked position and a locked position, and wherein when the disc is in the first position and the first lock lever is in the locked position, the radially projecting leg is engaged with the first lock lever, and when the disc is in the second position and the second lock lever is in the locked position, the radially projecting leg is engaged with the second lock lever.

5. The connector apparatus of claim 4, wherein the first lock lever and the second lock lever are engaged with each other such that both the first lock lever and the second lock lever move together between the unlocked position and the locked position.

6. The connector apparatus of claim 4, wherein the first lock lever and the second lock lever are biased towards the locked position.

7. The connector apparatus of claim 1, wherein the disc includes a first shoulder and a second shoulder, the first shoulder configured to selectively engage with the first pawl and the second shoulder configured to selectively engage with the second pawl, and wherein the first and second shoulders are axially offset from the radially projecting leg along the rotation axis.

8. The connector apparatus of claim 1, wherein the first pawl and the second pawl are configured to pivot at least between an engaged position with the disc and a disengaged position with the disc, and wherein when the first pawl is in the engaged position, the second pawl is in the disengaged position.

9. The connector apparatus of claim 8, wherein the connector directly contacts the first arm to move the second arm of the first pawl out of the engaged position.

10. The connector apparatus of claim 9, wherein the first arm and the second arm are arranged in a L-shape.

11. The connector apparatus of claim 8, wherein when the disc is in the first position, the first pawl is in the disengaged position and the second pawl is in the engaged position, and the first arm of the second pawl extends over the second notch of the disc.

12. The connector apparatus of claim 11, wherein to move the second pawl out of the engaged position, the first arm of the second pawl is pivoted completely past the second notch of the disc.

13. The connector apparatus of claim 8, wherein the locking mechanism includes two sets of first and second pawls, each set disposed on an opposite side of the disc.

14. The connector apparatus of claim 1, further comprising the connector and the second connector, the connector and the second connector identical to each other.

15. A method of connecting to a connector apparatus comprising:
providing a first connector secured to the connector apparatus, wherein the connector apparatus including a housing and a locking mechanism disposed at least partially within the housing, the housing having a first end and an opposite second end defining a longitudinal axis, the first end configured to couple to a line dispensing device, the housing defining a first channel and a second channel, the locking mechanism including a disc rotatable around a rotation axis orthogonal to the longitudinal axis, the disc having a first notch, a second notch, and a radially projecting leg, a first pawl and a second pawl, each pawl including a first arm positioned at a respective channel of the housing and a second arm selectively engageable with the disc, and at least one lock lever pivotably coupled to the housing, and wherein when the first connector is secured to the connector apparatus, the first connector is received within the first channel of the housing and the first notch of the disc such that the disc is rotated in a first position with the first connector disposed at a distal end of the first channel and the disc is rotationally locked with the locking mechanism with the second pawl engaged with the disc and the radially projecting leg is engaged with the at least one lock lever;
inserting a second connector into the second notch and the second channel so that the second connector actuates the first arm of the second pawl to release the second pawl from engagement with the disc;
actuating the at least one lock lever to release the radially projecting leg of the disc; and
once the second pawl and the at least one lock lever are disengaged from the disc, rotating the disc towards a second position whereby the second connector moves and secures within a distal end of the second channel via the first pawl and the at least one lock lever while simultaneously the first connector moves and releases from the distal end of the first channel of the housing.

16. The method of claim 15, wherein the locking mechanism further includes a biasing member supported within the housing, and the disc has a radially projecting lug engaged with the biasing member, and wherein rotating the disc between the first position and the second position includes overcoming a spring force of the biasing member.

17. The method of claim 15, wherein the at least one lock lever includes a first lock lever and a second lock lever, the first lock lever engaged with the second lock lever, and wherein actuating the at least one lock lever includes pivoting at least one of the first lock lever or the second lock lever from a locked position to an unlocked position.

18. The method of claim 15, wherein inserting the second connector into the second notch includes pivoting the first arm of the second pawl completely past the second notch of the disc to release the second pawl from the disc.

19. A connector apparatus comprising:
a housing having a first end and an opposite second end defining a longitudinal axis, wherein the housing defines a first channel and a second channel; and
a locking mechanism disposed at least partially within the housing and configured to secure a first connector to the housing while allowing a second connector to release the first connector and be simultaneously secured to the housing, the locking mechanism including:
a disc having a first notch, a second notch, and a radially projecting leg, the disc rotatable around a rotation axis orthogonal to the longitudinal axis between at least a first position whereby the first notch is aligned with a first opening of the first channel and a second position whereby the second notch is aligned with a second opening of the second channel;
a first pawl and a second pawl, each pawl having a first arm and a second arm, the first and second pawls oppositely pivotable between at least an engaged position whereby the second arm is engaged with the disc and a disengaged position whereby the second arm is disengaged from the disc; and
at least one lock lever pivotable between at least an unlocked position whereby the at least one lock lever is released from the radially projecting leg and a locked position whereby the at least one lock lever is engaged with the radially projecting leg,
wherein to release the first connector from the housing and simultaneously secure the second connector to the housing, the second connector is inserted into the second opening and the second notch to engage the first arm of the second pawl and move the second pawl towards the disengaged position, and additionally, the at least one lock lever is actuated towards the unlocked position, thereby allowing the disc to rotate towards the second position.

20. The connector apparatus of claim 19, wherein the at least one lock lever is mechanically independent from the first and second pawls.
